(19) United States
(12) Patent Application Publication
(10) Pub. No.: US 2005/0033514 A1
(43) Pub. Date: Feb. 10, 2005

(54) Mobile station of global position system for rubber-tyred gantry crane

(76) Inventor: Qing Lu, Shanghai (CN)

Correspondence Address: Min (Amy) S. Xu, Esq.;DORSEY & WHITNEY LLP, Intellectual Property Department, 50 South Sixth Street, Suite 1500, Minneapolis, MN, 55402-1498, US

(21) Appl. No.: 10/875,154

(22) Filed: Jun. 23, 2004

Related U.S. Application Data
(63) Continuation of application No. PCT/CN02/00842, filed on Nov. 25, 2002.

(30) Foreign Application Priority Data
Dec. 12, 2001 (CN) 01142631.4

(51) Int. Cl. G01C 21/26

(52) U.S. Cl. 701/213

(57) ABSTRACT

The present invention relates to a mobile station of Global Position System (GPS) for a rubber-tiered gantry crane (RTG), and it mainly comprises one or two GPS receiver(s), a radio receiver, two crane encoders, a control processor, and a programmable logic controller (PLC). The mobile station adopts Real Time Kinematics (RTK) technology of the GPS, and gets a high precision coordinates of three dimensions, then sends it to the control processor and gets the current crane position of the RTG and the offset between crane wheel and the central line of crane runway. At the same time, the control processor receives and calculates the signals sent by the crane wheel encoders, and checks up and reckons the crane position and the crane wheel offset, converts it to a 4-20 mA current signal by a digital-analog converter (D/A) or transfers it to the PLC directly by a serial port, and complete the crane auto-steering function; on the other hand, the control processor calculates the crane position and transfers it to the PLC via the serial port, completes the auto-register of the container management. The present invention can make the RTG keep agility with in moving from one yard to another, and can also make it work stable and reliably like a rail gantry crane and report the accurate container positions. Thus, the container management is made to be highly automotive.

### CROSS-REFERENCE TO RELATED APPLICATION(S)

This application is a continuation of International Application No. PCT/CN02/00842, filed on Nov. 25, 2002, which claims priority to Chinese Application No. 01142631.4, filed on Dec. 12, 2001, the contents of both applications are incorporated herein by reference.

### FIELD OF THE INVENTION

This invention relates to a rubber-tired gantry container crane (RTG), especially to a mobile station of Global Position System (GPS) for the rubber-tired gantry container crane.

### BACKGROUND OF THE INVENTION

International trade, which can't go without transportation of containers, activates the development of container loading/unloading machinery. The intense competition in goods shipping brings about the larger container ships and stimulates the upgrade of harbor container machinery. Being one of most attentive events among them, the demand for rubber-tired gantry container cranes (RTG) is increasing from year to year. And at the same time, the technical data of RTG are upgraded. For example, hoist height is increased from one over four, one over five to one over six, and now one-over-seven-high will come into existence; rated hoisting speed is getting higher from 15-16 mpm to 20-23 mpm with a tendency towards 32 mpm; rated load under spreader is changing from 30.5 tons to 40 tons and now 50 tons and twin-spreaders are under request. Automation degree of RTG is also being raised and the application of semi-automation of trolley and hoisting and the automatic operation management system of RTG are becoming popular.

Compared with rail-mounted gantry crane (RMG), RTG can more easily from yard to yard, however, by nature, it suffers from the following two drawbacks:

Position monitoring: Because it doesn't travel on fixed rails, RTG can't detect its relative position on the yard with typical encoders, and that gives no way for the yard management system to know the position of the RTG, thus resulting in imperfection of automatic container management. How to get the RTG position is now an issue to resolve to realize the automated container management, which consequently will increase the reliability and efficiency of operation.

Gantry auto-steering: Due to the fact that RTG doesn't travel on fixed rails and the construction feature of its own mechanism, RTG will be liable to deviate from the designed centerline while traveling; thus steering control is required. This requirement, on the one hand, will increase the operator fatigue, on the other hand, with the increasing of hoisting height (such as one over seven), will make the operator have more difficulty in observing the center line for manual steering, especially at night.

How to keep agility of RTG and keep it travel in the desired path without excessive deviation to obtain high automation of container management? In recent years different R&D departments from different fields are involved in looking into this requirement for solutions.

At present time there are GPS receivers with different specifications available in the market. These differences are related to the following specifications of receivers: frequency—some could only receive signals of L1 frequency and others could receive signals of both L1 and L2 frequency; measurement precision classification based on either meter, centimeter, or even millimeter level; processing technology inside—either DGPS or RTK etc. Those specifications will determine the precision degree, reliability, stability and response time of a GPS receiver, and in turn bring about the performance difference of RTG when applied.

Now a solution is coming true with the introduction of precision measurement of GPS (Global Position System) in industry field, especially when the measurement precision at millimeter level is attainable.

### BRIEF SUMMARY OF THE INVENTION

The invention is a mobile station of GPS for application on RTG that will solve the above-mentioned problems. The station could make the RTG keep its agility in moving from yard to yard, travel straightly and report container position accurately just like an RMG.

The technology involved in this invention is as follows:

A mobile station of Global Position System (GPS) for a rubber-tired gantry container crane (RTG), wherein the mobile station mainly comprises one or two GPS receiver(s), a radio receiver, two crane encoders, a control processor and a programmable logic controller (PLC); wherein the mobile station achieves its coordinate data of three dimensions in high precision based on the Real Time Kinematics (RTK) technology of GPS in carrier phase, and sends them to the control processor which calculates the current position of the RTG and the offset between an RTG wheel and the central line of the crane racetrack; and at the same time, the control processor receives and calculates the signals transmitted by the encoders in the RTG to check the RTG position and the offset, and thus reckon a crane wheel offset which in turn, is converted, through an analogue to digital converter (D/A), into 4-20 mA current signal, or directly delivered, through a serial port, to a PLC to control the RTG for auto steering; on the other hand, the RTG position calculated by the control processor is sent, through a serial port, to the PLC, resulting in an automatic register of the RTG container operation.

The invention can make the rubber-tired gantry crane keeping agility in moving from yard to yard, and can also make it work stable and reliably like a rail-mounted gantry crane, and report container positions accurately and easily.

### BRIEF DESCRIPTION OF THE DRAWINGS

FIG. 1 schematically illustrates the mobile station of GPS for RTG application of this invention.

FIG. 2 illustrates the principal flow chart of the mobile station of GPS of this invention.

### DETAILED DESCRIPTION OF THE INVENTION

Based on consideration of GPS that will be applied on RTG, the type of GPS we selected has carrier phase real-time differential technology (RTK) inside and the system configuration is as follows:

The whole project of RTGs will be equipped with one GPS base station. It consists of a dual-frequency GPS receiver and a modulating radio transmitter. The function of the base station is to send correction data of GPS position to each crane station.

Each crane will be equipped with a GPS mobile station that consists of one or two GPS receiver(s) and a common radio receiver. This mobile station will check the current position of the RTG with a precision at centimeter level. The position signal will be processed in the main computer and then sent to the PLC to be dealt with for the management of container position and auto steering control etc.

The whole GPS is compact, simple and independent, and it is easy to be installed on RTG without imposing any influence on the mechanical design.

The mobile station of GPS will be installed inside an electrical room on RTG. It is mainly comprised of a GPS module, a processor unit, a radio station, a power supply and PLC etc. In addition, GPS antennas and a radio antenna and cables are installed on the RTG. The GPS module will receive differential signals from the remote base station on yard and generate position data of centimeter level precision for the processor. The processor gets the position data via a serial port. At the same time the processor will gather gantry motor encoder's signals to deal with the gantry position and the offset values. Signals from both GPS and encoders are dealt with in the processor: GPS provides X/Y positions of RTG on yard while the encoders are used to deduce and double check the positions; they complement each other hence the whole product increases the update speed of position information and maintains the accuracy of position data. Several indicators are installed on the front panel of processor unit to indicate the status of power supply, operation condition, GPS position and radio link etc. The gantry position and offset values in the processor are further transferred to the PLC on the RTG via RS232 communication for control and calculation of gantry auto steering function and container management.

The RTK technology is based on the calculation of two GPS station's real time data. Due to errors in the receiver clock and interference from sky, a stand-alone receiver has a positioning accuracy above 10 meters. By using RTK, the accuracy could be increased largely to centimeter level: One GPS receiver is put on a reference station, where the accurate coordinates of the station are known. This receiver is used to observe, and calculate the correction data of the distance from the station to satellites; then those correction data are sent out via a modulated radio wave. The users receiver on the RTG, while observing the satellites, gets the correction data sent from the reference station, and correct its observation, then the position precision is raised.

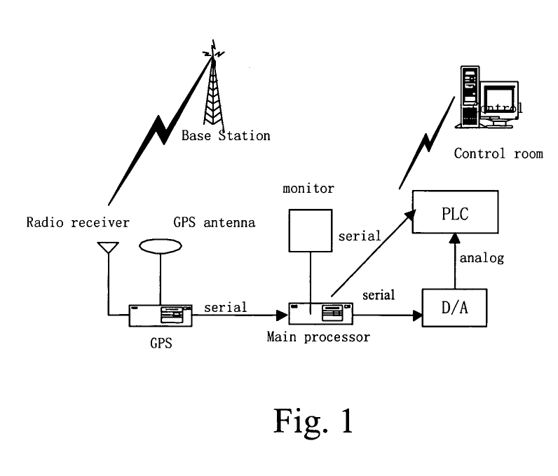

Refer to FIG. 1, the application of the invention includes a control center, a GPS base station and a mobile station on RTG.

The base station receives GPS signals and broadcasts correction data via a radio transceiver. The mobile station receives GPS signals too, at the same time, however, it also receives the correction data from the base station. Then the mobile station calculates the RTG's position at centimeter level. This position data are transferred to the PLC on the RTG for control of auto steering of gantry and container management.

The control center has a database of all the containers, including container postions, container types and their owenrs etc. Also the yard information such as yard area, RTG travel path and truck path are stored in that database. All the RTG's operation status is sent to the database. The control center manages all the data, and controls the RTG's operation and container movement.

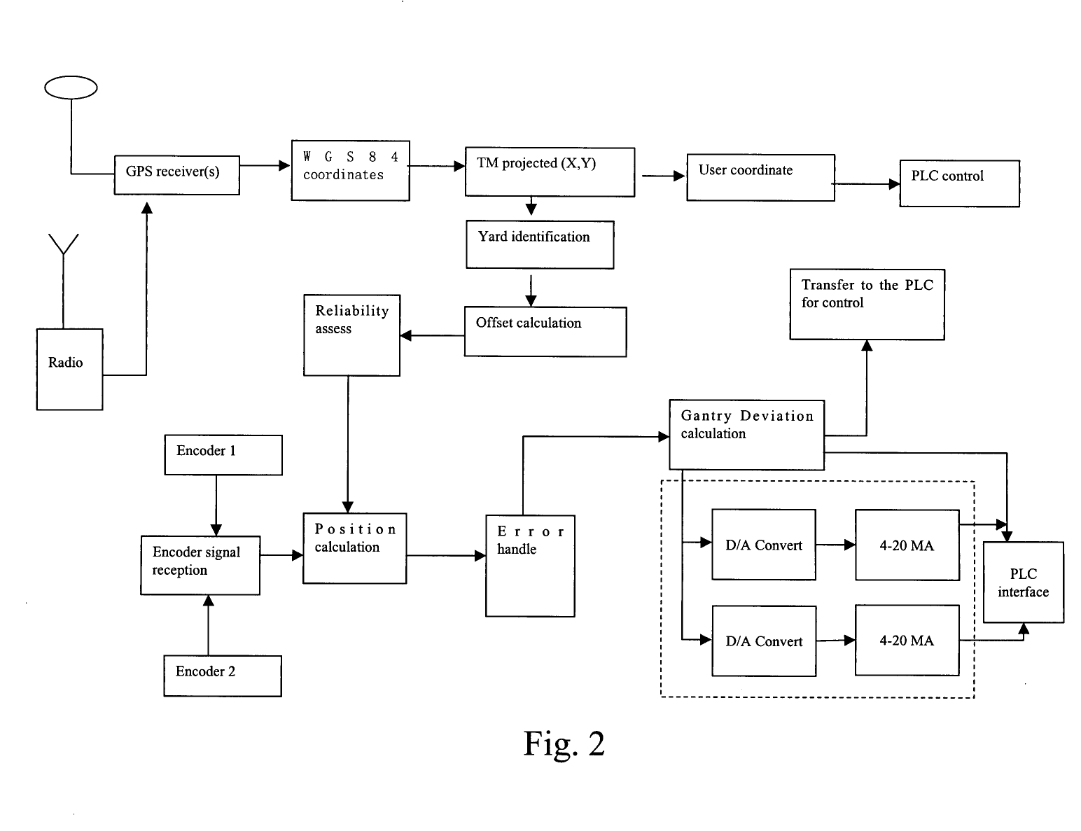

Refer to FIG. 2, the control principle of the mobile station is as follows:

The mobile station mainly consists of one or two GPS receiver(s), a radio, a micro-processor, and a PLC. Since the RTG could travel at 2 m/s, the GPS receivers should at least output a position signal per second in order to efficient control the RTG. The GPS receivers output position data at centimeter level to the processor via a serial port; the processor also acquires gantry encoder signals to aid the position calculation. Status of the power supply, the GPS receiver operation, radio link and encoder signals are displayed on the front panel of the processor.

The PLC gets the position data from the processor via serial communication. Then it controls the gantry auto steering function. Also it will calculate the current positions of RTG and the containers handled in real-time mode. Such information could be transmitted wirelessly to the remote control center.

The mobile station could also be adpated for different application.

### Industrial Application

While selecting the type of the GPS receivers for the RTGs, the following specifications of RTG were taken into consideration:

Gantry speed: Currently the typical gantry speed is between 90 mpm-120 mpm, i.e., 1.5 m/sec.-2 m/sec. Correspondingly, the GPS should update fast enough to follow the changing position of RTG.

Measurement precision: The container yard is generally laid out so compactly that two RTGs will have a safety distance of around 750 mm while crossing each other on adjacent paths. Thus we require the GPS to have a measurement precision high enough to suit the needs of position monitoring and auto steering control.

Initialization time: When cold started, the GPS receivers need a certain time to lock to the satellites and initialize its calculation. We designate the time to be less than 3 minutes in order to satisfy its operator.

With the mobile station invented, the following functions could be achieved on RTG:

Container management: While equipped with GPS, the RTG could detect its current position all the time in operation and convert the position data of the container being handled into the definite bay number and vice versa in the PLC.

Gantry auto-steering function: By processing the position acquired with the GPS in the PLC software the RTG could realize auto-steering while traveling which will greatly alleviate the fatigue degree of its operator.

Helpful to semi-automatic function: It will be helpful for the RTG, which is equipped with GPS mobile station to be upgraded into semi-automated operation including mechanisms of hoisting, trolley and gantry in the near future, which will in turn establish a basis for a higher degree of automation of the RTG.

1. A mobile station of Global Position System (GPS) for a rubber-tired gantry container crane (RTG), wherein the mobile station mainly comprises one or two GPS receiver(s), a radio receiver, two crane encoders, a control processor and a programmable logic controller (PLC); wherein the mobile station achieves its coordinate data of three dimensions in high precision based on the Real Time Kinematics (RTK) technology of GPS in carrier phase, and sends them to the control processor which calculates the current position of the RTG and the offset between an RTG wheel and the central line of the crane racetrack; and at the same time, the control processor receives and calculates the signals transmitted by the encoders in the RTG to check the RTG position and the offset, and thus reckon a crane wheel offset which in turn, is converted, through an analogue to digital converter (D/A), into 4-20 mA current signal, or directly delivered, through a serial port, to a PLC to control the RTG for auto steering; on the other hand, the RTG position calculated by the control processor is sent, through a serial port, to the PLC, resulting in an automatic register of the RTG container operation.
